(19) United States
(12) Patent Application Publication
(10) Pub. No.: US 2015/0265979 A1
(43) Pub. Date: Sep. 24, 2015

(54) Aerator

(71) Applicant: Clearwater Controls Limited, Grangemouth (GB)

(72) Inventor: Graham McIvor, Grangemouth (GB)

(21) Appl. No.: 14/662,499

(22) Filed: Mar. 19, 2015

(30) Foreign Application Priority Data
Mar. 19, 2014 (GB) 1404957.1

(51) Int. Cl. B01F 3/04; C02F 1/74

(52) U.S. Cl. CPC B01F 3/0478; C02F 1/74; B01F 2215/0052

(57) ABSTRACT

The present invention relates to an aerator apparatus. It comprises an aerator with at least one blade driven around a central axis, and a motor coupled to the at least one blade such that the operation of the motor in a first or a second direction results in the operation of the blade in a corresponding first or second direction. The aerator apparatus further comprises a control device comprising a monitoring mechanism to monitor the current drawn by the motor; and a control mechanism to control the direction of the motor. The monitoring mechanism detects a certain value of the current drawn by the motor and the control mechanism is adapted to direct the motor and coupled at least one blade operating in the first direction to do at least one of (i) stop and/or (ii) operate in the second direction. In preferred embodiments, the monitoring mechanism monitors the current drawn by the motor in relation to one or more of the voltage and frequency applied to the motor. An advantage of certain embodiments of the present invention is that they provide an economical unblocking solution for wastewater aerators where the control device detects a change in the current drawn by the motor, and instructs the motor to direct the aerator into a clean cycle to try to dislodge debris built up during normal flow, when the aerator is running clean.

### CROSS REFERENCE TO RELATED APPLICATIONS

The present application claims priority under 35 U.S.C. §119 to United Kingdom Patent Application Serial No. 1404957.1 filed on Mar. 19, 2014, the disclosure of which is incorporated herein by reference.

### RELATED ART

1. Field of the Invention

The present disclosure relates to an aerator apparatus comprising an aerator, motor and a control device.

2. Brief Discussion of Related Art

Aerators are devices used to add air to water. This is often required in anoxic conditions, which may be caused by the presence of human sewage. These anoxic conditions do not promote the breakdown of waste material. Aerators may be used to oxygenate the wastewater to allow aerobic respiration by bacteria which promotes more efficient breakdown of the waste material.

Aeration blockages contribute a significant cost to water authorities operational spend by having to unblock in order to improve dissolved oxygen levels in the aeration chamber/tanks.

It would be beneficial to mitigate the amount of maintenance required on certain aerators. Also, vibration caused by blockages causes extra wear and tear on bearings and gearboxes.

Moreover, it would be beneficial to improve the power efficiency of the motor by improved efficiency of the aerator.

U.S. Pat. No. 6,379,109 describes a method and apparatus for detecting and removing obstructions in mechanical aerators using a vibration sensor. When the sensor detects excessive vibrations in the rotating shaft, often caused by debris attached to the propeller, the motor is automatically shut down and then run in the reverse direction causing the debris to be thrown off the propeller.

### INTRODUCTION TO THE INVENTION

An object of the present invention is to mitigate any maintenance requirements and/or improve the power efficiency of aerators.

According to a first aspect of the invention, there is provided an aerator apparatus comprising: (a) an aerator with at least one blade driven around a central axis, and a motor coupled to the at least one blade such that operation of the motor in a first or a second direction results in operation of the blade in a corresponding first or second direction; (b) a control device comprising a monitoring mechanism to monitor the current drawn by the motor; and, (c) a control mechanism to control the direction of the motor, where when the monitoring mechanism detects a certain value of the current drawn by the motor, the control mechanism is adapted to direct the motor and coupled at least one blade operating in the first direction to do at least one of (i) stop and/or (ii) operate in the second direction.

The present invention monitors the current drawn by the motor, whereas U.S. Pat. No. 6,379,109 monitors the vibration of the aerator itself (as detailed in, for example, FIG. 1—item 2, FIG. 2—item 2 and claim 1). The inventor of the present invention has discovered an important benefit of such an approach since the monitoring of the current according to the present invention is often more accessible (on land at the edge of a body of water) than the monitoring of variables such as the vibration on the aerator itself, which is often on the body of water out of reach. Thus one or more of installing, monitoring, servicing, replacing and repairing may be easier and/or quicker on land than having to recover an aerator from a body of water.

The motor may be a mechanically switched motor. Alternatively, the motor may be a variable speed motor. The motor may be a three phase motor. The motor may be operable on a 3-phase power supply. The motor may be operable on a gearbox.

The motor used in the present invention is capable of being operated in a first direction and/or a second direction. This includes motors where the existing control system only functions to instruct the motor to direct the aerator in a first direction and a stop position and not a second direction.

The first and second directions are typically opposite directions. The first direction may be a ‘forward’ direction. The second direction may be a ‘reverse’ direction. These ‘forward’ and ‘reverse’ directions are often arbitrary.

Preferably the monitoring mechanism monitors the current drawn by the motor in relation to one or more of the voltage and frequency applied to the motor. Where the motor according to the present invention is a variable speed motor, these typically use measurement of the current in relation to one or more of the voltage and frequency applied to the motor to detect a blockage on the aerator. The voltage and frequency applied to the motor will have an associated current. If the actual current drawn by the motor differs from the associated current, this may be indicative of a blockage on the aerator.

The speed of the motor is proportional to the voltage and the frequency. Thus, the speed of the motor can be approximated using the voltage and the frequency applied to the motor.

The current drawn by the motor is normally the input current to the motor.

In some embodiments, the input current to the motor may be monitored. In other embodiments, the power input of the motor may be monitored.

Thus, the current drawn by the motor may be determined by monitoring the current drawn directly (e.g. by using a current transformer) or by monitoring the power input of the motor and calculating the current drawn.

The monitoring mechanism monitors whether the current is outside a normal operating range to an extent indicative that the aerator may be blocked. The monitoring mechanism may monitor whether the current is outside a normal operating range in relation to at least one of the voltage and frequency, to an extent indicative that the aerator may be blocked. Directing the motor, operating in the first direction, to at least one of (i) stop and (ii) operate in the second direction, may assist in clearing any blockage.

The trigger points may be determined by stored value(s).

The trigger point typically varies depending on the voltage and frequency applied.

Thus a particular level of current drawn may trigger the control mechanism to direct the motor when reference to the voltage and/or frequency indicates this is beyond a certain stored value. Where said particular level of current drawn occurs where the voltage and frequency are at different values, this may not trigger the control mechanism to direct the motor.

Thus one or more of a table, graph or chart may be created which contains values for the current, the increased and/or decreased current in relation to one or more of the voltage and frequency or run-time of the motor which may correspond to an aerator blockage. The values may be single numbers above which, or a range of numbers within which, the aerator may be considered blocked. The one or more of the table, graph or chart may correspond to a single type of aerator. The one or more of the table, graph or chart may correspond to multiple types of aerator.

The trigger points may be determined by calculation rather than stored values. A combination of stored values and calculations may be used.

Preferably the aerator comprises a plurality of blades which may rotate around at least one central axis. The blades are normally aerator blades. The blades may be any suitable shape, including, but not limited to, flat, curved and paddled shaped.

The motor, and a gearbox and a shaft component of the aerator apparatus are typically located above the water surface. The aerator blades are normally located at a fixed height, typically at or just submerged under the water surface. The aerator typically draws air into the water due to the rotation of the blades.

The motor may be equally as efficient in the first direction as in the second direction. The aerator may be equally as efficient in the first direction as in the second direction.

It is an advantage of certain embodiments that the motor and the aerator are equally as efficient in the first direction as in the second direction. The motor and the aerator may be operated in the first direction or the second direction for at least 30 seconds, optionally at least five minutes, but may be much longer such as more than 5 hours, or more than 20 hours.

Where the first direction is the ‘forward’ direction and the second direction is the ‘reverse’ direction, the motor and the aerator are equally as efficient in the ‘reverse’ direction as in the ‘forward’ direction. The motor and the aerator may be driven in the ‘forward’ direction or the ‘reverse’ direction for at least 30 seconds, optionally at least five minutes, but may be much longer such as more than 5 hours, or more than 20 hours.

The duration of the first and the second direction may be varied by the user.

A stage as used herein comprises the first direction or the second direction. A cycle as used herein comprises the first direction, followed by a stop, followed by the second direction, followed by another stop.

Where the first direction is the ‘forward’ direction and the second direction is the ‘reverse’ direction, a stage comprises the ‘forward’ direction or the ‘reverse’ direction. Furthermore, a cycle comprises the ‘forward’ direction, followed by a stop, followed by the ‘reverse’ direction, followed by another stop.

The control mechanism may be adapted to direct the motor and coupled at least one blade to perform a plurality of cycles. For example two or more cycles.

A cycle may be referred to as a clean cycle.

When the monitoring mechanism detects that the current is outside a normal operating range or that the current is outside a normal operating range in relation to at least one of the voltage and frequency, the control mechanism preferably initially directs the motor, operating in a first direction, to (i) stop, for example by stopping power to the motor. When the power to the motor is stopped, this may allow the aerator to coast to a rest. Preferably the control mechanism then directs the motor into the second direction. The motor may again be stopped and the aerator allowed to coast to a rest. The control mechanism may then direct the motor into the first direction.

Preferably there is a user adjustable stopping period of from 0 to 60 seconds, but not limited thereto, between direction changes i.e. between each stage. When a variable speed motor is used, the stopping period may be 0 seconds. When a mechanically switched motor is used the stopping period may be at least 5 seconds, for example.

The stopping period allows the aerator to come to a rest before a direction change and so reduces the stress on the motor and/or gearbox. The inertia of the aerator and the fluid continuing to pass therethrough typically keeps the aerator running in the same direction, for example the first direction, for a short period of time after the power is cut. Thus after the power is cut to the motor, the motor will preferably wait for a pre-defined period of time before progressing to the next stage, for example the second direction. The waiting time may be varied by the user and is typically larger for larger motors.

Preferably the control device may be configured to perform cycles for a set period, or until the current returns to within a normal operating range, optionally in relation to one or more of the voltage and the frequency, indicating that no blockage is present. For example, where the current returns to within a normal operating range, the cycles may be stopped. This “reset” point may be the same as the trigger point, or different.

Alternatively or additionally, the cycles may be stopped after it reaches a pre-defined maximum number of cycles. The maximum number of cycles may be varied by the user.

Typically, when the maximum number of clean cycles is reached, the motor is tripped. Typically, when the maximum number of clean cycles is reached an alarm is also sounded.

The control mechanism may comprise a counter to record the number of clean cycles. The counter may be reset once the device has been running clean for a period of time which can be varied by the user.

An advantage of certain embodiments of the present invention is that they provide an economical unblocking solution for wastewater aerators where the control device detects a change in the current drawn by the motor, and instructs the motor to direct the aerator into a clean cycle to try to dislodge debris built up during normal flow, when the aerator is running clean.

Another advantage of certain embodiments of the present invention is that the blockage is removed from the aerator by the control panel, mitigating the need for manual intervention.

The monitoring mechanism may also be adapted to monitor the current supplied to the motor with regard to potential overloading of the motor.

As the real-time current supplied to the motor is monitored, the device may also act as motor protection as it may comprise a thermal image algorithm of the motor. This may allow the device to act like a traditional motor thermal overload.

Standards for excess current being supplied to motors are often imposed by regulatory authorities to safeguard against overheating. These limits, which depend on a number of different variables, can be stored by the control device and the control mechanism may be adapted to control the motor or another device in response to an overload breaching a pre-determined safety level, which is indicative of the motor overheating. Other devices the control mechanism may control include alarms.

Components for monitoring the current drawn by the motor may be provided on a bimetallic strip.

Preferably the components for monitoring the current drawn by the motor, and the components adapted to monitor the potential overloading of the motor, are provided on the same device which may be a bimetallic strip. Said components can thus together be conveniently retrofitted to an existing aerator by replacing an existing component which may be for monitoring potential overloading of the motor.

The monitoring mechanism may also comprise a monitoring means to detect any sudden change or short circuit in the current supplied to the motor, and the control mechanism is normally adapted to suitably respond to such an event, for example by shutting down the motor.

Preferably on start-up, the control device instructs the motor to direct the aerator to proceed through at least one clean cycle comprising a pre-determined number of direction changes, wherein each direction runs for a pre-defined period of time.

An advantage of embodiments of the present invention may be that the aerobic respiration by bacteria in wastewater, which is required to completely break down the waste, is significantly improved. Thus, the processing of wastewater may be improved.

A further advantage of certain embodiments of the invention is that the control device can be provided on a single device, thus saving space.

The physical size of the control device may be minimised to enable greater use of the product. Preferably the size is less than 104 mmH×40 mmW×150 mmD.

Due to the physical size of the control device, certain embodiments of the invention may be designed to be retro-fitted into an existing motor starter panel.

The control device may be easily retro-fitted into the existing motor starter panel as it replaces thermal/electronic overload devices. The control device monitors the current drawn by the motor in real time, optionally in relation to one or more of the voltage and the frequency, and where it lies outwith normal operating parameters or after a pre-defined period of run-time of the motor, it may trigger the motor, operating in the first direction, to at least one of (i) stop and (ii) operate in the second direction.

Optionally there is a sensor which measures the current. More optionally there is a sensor which measures the current and one or more of the voltage and frequency. The sensor may be retro-fitted by attaching it to an existing power cable for the motor. The sensor is typically also connected to the control device. This has an advantage that no additional cables need to be installed directly to the motor for embodiments of the present invention to operate. This may be an advantage because the motor itself may be difficult to access if it is situated in the middle of a pond or tank. The sensors may or may not be part of the apparatus.

The power efficiency for certain embodiments may be improved because the motor does not have to contend with any drag due to blockages on the aerator blades.

The control mechanism may further comprise a counter to record the run-time of the motor. Once a pre-defined run-time has expired, at least one clean cycle may be initiated. The counter may be reset once the at least one clean cycle has completed.

The run-time before a clean cycle is initiated may be set and varied by the user. Typically it may be set to initiate at least one clean cycle after 20 to 60 minutes of motor run-time.

Any feature of the first aspect of the present invention may be combined with the second aspect and/or the third aspect of the present invention.

According to a second aspect of the present invention, there is provided an aerator apparatus comprising: (a) an aerator with at least one blade driven around a central axis and a motor coupled to the at least one blade such that operation of the motor in a first or a second direction results in operation of the blade in a corresponding first or second direction; and, (b) a control mechanism to control the direction of the motor, where after a pre-determined run-time of the motor the control mechanism is adapted to direct the motor and coupled at least one blade operating in the first direction to do at least one of (i) stop (ii) operate in the second direction.

The run-time of the motor may be defined as the length of time the motor has been operating for after start-up. The pre-determined run time may be at least 15 minutes, or at least 20 minutes; and may be up to 1 hour, or up to 30 minutes.

Preferably a trigger point is further defined for the run-time of the motor. In this embodiment in accordance with the second aspect of the invention, the current may or may not be monitored. A clean cycle may be initiated when the current is within a normal operating range indicating that no blockage is present.

The aerator apparatus is configured to operate in a first normal operating range, and said certain value is outwith this first normal operating range. This range may be from 85% to 95% of the current available to the motor.

For certain embodiments, the aerator apparatus is configured to switch between operating in the first normal operating range and a second normal operating range; said certain value when detected in use, being outwith the normal operating range being used at that moment in time, by the aerator apparatus. The second normal operating range is normally different to the first normal operating range, although there may be an overlap. For example, the second normal operating range may be 60-85% or 65-75% of the current available to the motor.

Thus the certain value which causes the control mechanism to direct the motor as described herein, is outside the first normal operating range if the aerator is operating in this first range, and outwith the second normal operating range if the aerator is operating in this second range.

A switch on a digital input can be activated to switch the aerator apparatus between first and second normal operating ranges.

In use, the second normal operating range can be used when a bubble diffuser operates with the aerator.

A bubble diffuser releases bubbles of air which further oxygenates the wastewater, thus further improving the breakdown of waste material. The presence of bubbles in the water may cause the current drawn by the motor to change due to the cavitation. Normally, the presence of bubbles in the water causes the current drawn by the motor to decrease.

The current drawn by the motor is normally directly proportional to the torque of the motor. Therefore, the presence of bubbles in the water may cause the torque profile of the motor to change. Normally, the presence of bubbles in the water causes the torque of the motor to decrease.

An advantage of certain embodiments of the present invention is that having a second normal operating range in the presence of an active bubble diffuser mitigates the risk of the control device incorrectly detecting that the aerator is blocked and unnecessarily instructing the motor to direct the aerator into a clean cycle. Moreover the normal operating range can be narrower which detects blockages more readily, rather than being a wider range to cover use with and without a diffuser.

Any feature of the second aspect of the present invention may be combined with the first aspect and/or the third aspect of the present invention.

According to a third aspect of the present invention, there is provided a system comprising an aerator apparatus according to the first or second aspects of the present invention, and a bubble diffuser.

The bubble diffuser is typically provided below the aerator apparatus and beneath the water level.

The bubble diffuser may take a variety of forms. For example, it can be a cylindrical strip of material comprising evenly spaced apertures. Alternatively it may be a permeable hose made from a flexible material such as cloth. Plastics and composite materials are also suitable.

Air present within the strip may pass through the apertures to the surrounding water. Alternatively, the bubble diffuser may be disc shaped.

Any feature of the third aspect of the present invention may be combined with the first aspect and/or the second aspect of the present invention.

### BRIEF DESCRIPTION OF THE DRAWINGS

Embodiments of the present invention will now be described, by way of example only, with reference to the accompanying figures.

FIG. 1 is a flowchart showing the stages of a device in accordance with the present invention.

FIG. 2 is a circuit diagram indicating electrical connections and a typical retro-fit installation.

FIG. 3 is a side view of an aerator apparatus and a bubble diffuser.

FIG. 4 is a flowchart showing the process behind changing the torque profile.

### DETAILED DESCRIPTION

The exemplary embodiments of the present disclosure are described and illustrated below to encompass an aerator apparatus comprising an aerator, motor and a control device. Of course, it will be apparent to those of ordinary skill in the art that the embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

There is herein described an apparatus comprising an aerator with a number of flat aerator blades driven around a central axis. Coupled to the aerator is a variable speed motor which can be operated in a first and a second direction. Operation of the motor in the first or second direction results in the operation of the aerator in a corresponding first or second direction. The apparatus further comprises a control device which is connected to the motor. The control device comprises a monitoring mechanism and a control mechanism. The monitoring mechanism monitors the current drawn by the motor in relation to the voltage and the frequency applied to the motor. The control mechanism controls the direction of the motor.

The voltage and the frequency are related to the speed of the motor. As the voltage and the frequency change, they have an associated current drawn by the motor. If the current drawn falls outwith a normal operating range, i.e. if the current goes too high or too low in relation to the voltage and the frequency, this indicates a blockage. To determine if there is a blockage, a look up table is used for the current.

The first direction is a ‘forward’ direction and the second direction is a ‘reverse’ direction. The normal operation of the motor is in the ‘forward’ direction. When the monitoring mechanism detects a value of the current outwith a normal operating range in relation to the voltage and the frequency, the control mechanism instructs the motor to first stop and then to operate in the ‘reverse’ direction. This has the effect of first stopping the aerator, and then operating the aerator in the ‘reverse’ direction.

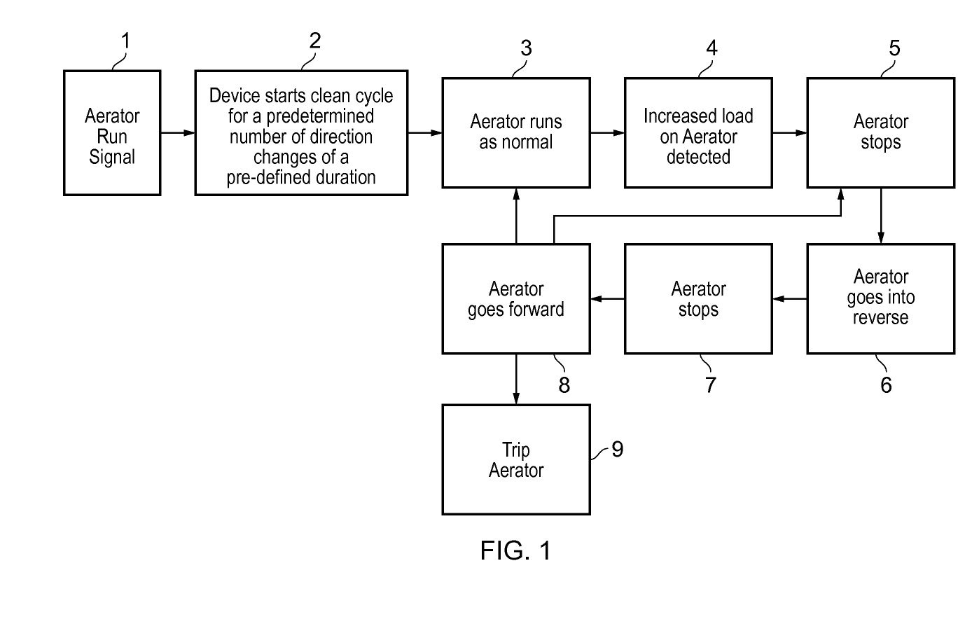

As shown in FIG. 1, when the motor is first turned on, step 1, it will direct the aerator through a start-up clean cycle which comprises a pre-determined number of direction changes, step 2. The duration of the ‘forward’ direction and the duration of the ‘reverse’ direction is the same. The waiting period between the ‘forward’ direction and the ‘reverse’ direction, and the ‘reverse’ direction and the ‘forward’ direction, is the same. The motor then directs the aerator to run as normal in a ‘forward’ direction, step 3, until an increased load on the motor is detected, step 4, by the motor drawing a current outwith a normal operating range in relation to the voltage and the frequency, indicating a blockage. The control device will then instruct the motor to initiate the clean cycle which starts by cutting power to the motor, step 5. The inertia of the aerator and the wastewater continuing to pass therethrough will keep the aerator running in the ‘forward’ direction for a short period of time after the power is cut—the aerator will “coast” to a rest. After the power is cut to the motor it will wait for a pre-defined period of time “A” before progressing to the next step.

After the period of time “A”, the motor directs the aerator into the ‘reverse’ direction, step 6, for a pre-defined period of time “B”. After the period of time “B”, the motor stops again, step 7, and allows the aerator to coast to a rest. After a further period of time “A” the motor directs the aerator into a ‘forward’ direction, step 8, for a pre-defined period of time “C”.

In this example, the duration of “B” and “C” may be 45 seconds and the duration of “A” may be 10 seconds.

The above clean cycle (steps 5 to 8) is repeated up to a pre-defined maximum number of clean cycles which is set by the user. The control mechanism comprises a counter to record the number of clean cycles. Once the pre-defined maximum number of clean cycles is met, the control device has a number of options.

If the blockage is cleared, as indicated by the current returning to within a normal operating range in relation to the voltage and the frequency, then the motor will direct the aerator to resume normal operation in the ‘forward’ direction, step 3.

When the aerator has been running clean for a period of time set by the user, the counter will be reset. If the blockage is still present, the device will trip the motor, step 9, and sound an alarm.

The run-time of the motor is measured by a second counter on the control mechanism. When the pre-defined run-time is met, the control device will initiate a clean cycle (steps 5 to 8), even if the current is within a normal operating range in relation to the voltage and the frequency, meaning no blockage is detected. Once the clean cycle has completed, the second counter will reset and the motor will direct the aerator to resume normal operation in the ‘forward’ direction, step 3.

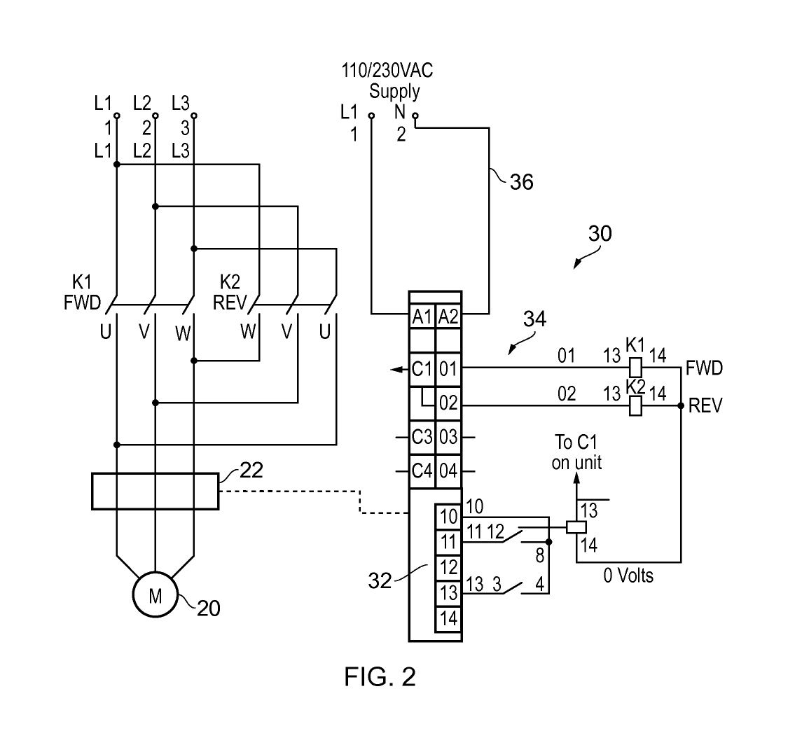

FIG. 2 shows a circuit diagram for the FIG. 1 embodiment and illustrates how the present control device can be retrofitted to a pre-existing motor starter panel. The pre-existing motor 20 is supplied by a three-phase power supply L1, L2, L3. A contactor K1 is provided to engage the motor 20 into a ‘forward’ direction, or to disengage the power from the motor 20 and allow it to stop. The system can be modified to utilise an embodiment of the present invention by connecting a contactor K2 in parallel to the switch K1. The switch K2 can be engaged to direct the motor 20 into a ‘reverse’ direction.

Also added to the existing configuration, downstream of the switches K1 and K2 and upstream of the motor 20, is a current sensor 22 to monitor the current being supplied to the motor 20. The current sensor is connected to a control device 30.

The control device 30 has an input interface 32, an output interface 34 and a power supply 36. The input signals are received and processed by the input interface 32 and the appropriate outputs are activated, as described above with respect to FIG. 1. The outputs 01 and 02 from the output interface 34 control the contactors K1 and K2 or the reverse signal to a variable speed drive which in turn control the motor 20.

The existing coil or start signal connection to the contactor K1 is rerouted to the control device 30. This provides the run signal. From there the control device takes control of the motor.

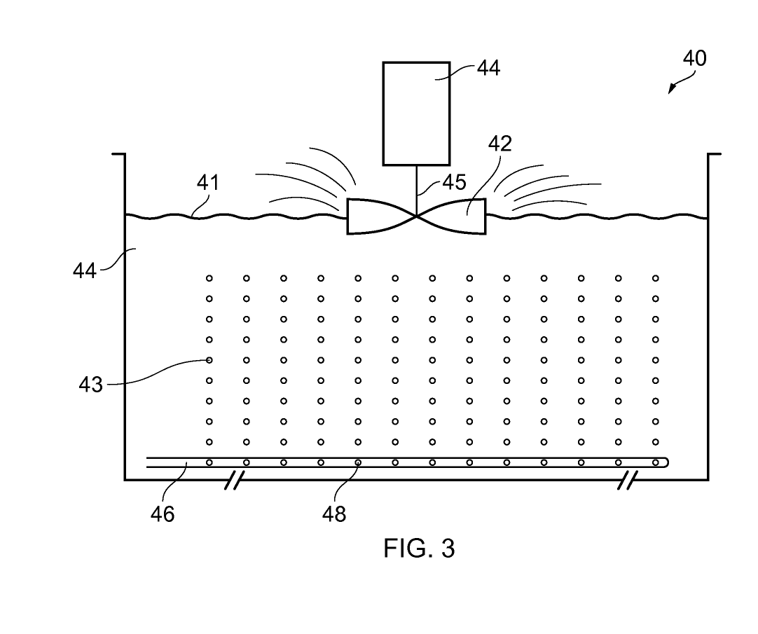

FIG. 3 shows an aerator apparatus 40 comprising an aerator with a plurality of blades 42 driven around a central axis 45. A motor 44 is coupled to the aerator blades 42 and can drive the aerator blades in a forward direction or a reverse direction.

The motor 44 and the central axis 45 sit above the water level 41. The aerator blades 42 are partially submerged below the water level 41.

A bubble diffuser 46 is provided with the aerator apparatus 40.

In use, the bubble diffuser 46 releases bubbles of air which, in addition to the aerator apparatus 40, oxygenates the wastewater, thus improving the breakdown of waste material.

The bubble diffuser 46 is provided directly below the aerator apparatus 40 and beneath the water level 41. The bubble diffuser 46 is a cylindrical strip of material comprising evenly spaced apertures 48.

The normal operating range discussed above in relation to FIG. 1 is known as a first normal operating range. When an active bubble diffuser is provided, a second normal operating range is defined.

The first normal operating range of the current drawn by the motor may be from 88% to 92% of the current available to the motor. When the bubble diffuser is active, the current drawn by the motor drops to 70% of the current available to the motor. Therefore, the second normal operating range of the current drawn by the motor is from 68% to 72% of the current available to the motor.

In use, when the bubble diffuser 46 is active, air bubbles 43 are released from the apertures 48. The presence of air bubbles 43 causes the current drawn by the motor 44 to decrease, and thus the torque of the motor 44 will also decrease.

The control device is prevented from incorrectly detecting a blockage and initiating a clean cycle, by switching the torque profile of the motor from the first normal operating range to the second normal operating range.

In the presence of the active bubble diffuser, the current must be monitored with respect to the second normal operating range, otherwise the control device will indicate a blockage where none is present and the motor will incorrectly be instructed to initiate a clean cycle, as shown in steps 4 to 9 of FIG. 1.

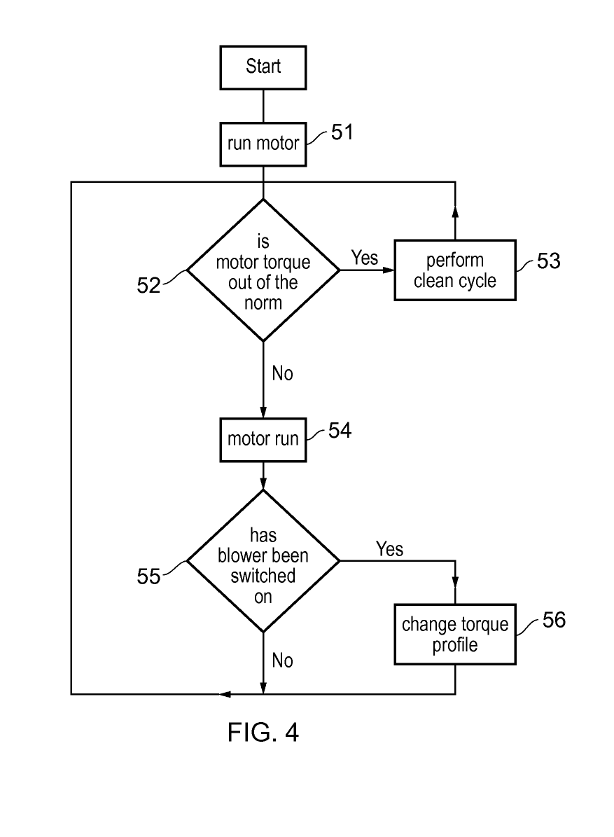

The flowchart in FIG. 4 shows the procedure for switching the torque profile from the first normal operating range to the second normal operating range. The bubble diffuser may be initially switched off when the motor starts running 51. As soon as the motor is started 51, the control device monitors the current drawn by the motor 52. If the control device detects that the current drawn, which is proportional to the torque of the motor, is outwith the first normal operating range in relation to the voltage and the frequency applied to the motor, then it initiates a clean cycle 53. If the control device detects that the current drawn is within the first normal operating range in relation to the voltage and the frequency applied to the motor, then the motor is allowed to continue to run as normal 54.

Alternatively, the bubble diffuser may be switched on before the motor or at the same time as the motor.

The control device then checks the status of the bubble diffuser 55. If the control device detects that the bubble diffuser has been switched on, it changes the torque profile 56 and begins monitoring the current drawn by the motor 52 using the second normal operating range.

Following from the above description and invention summaries, it should be apparent to those of ordinary skill in the art that, while the methods and apparatuses herein described constitute exemplary embodiments of the present invention, the invention contained herein is not limited to a precise embodiment and that improvements and modifications may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. An aerator apparatus comprising:
an aerator with at least one blade driven around a central axis, and a motor coupled to the at least one blade such that operation of the motor in a first or a second direction results in operation of the blade in a corresponding first or second direction;
a control device comprising a monitoring mechanism to monitor the current drawn by the motor; and
a control mechanism to control the direction of the motor;
wherein when the monitoring mechanism detects a certain value of the current drawn by the motor, the control mechanism is adapted to direct the motor and coupled at least one blade operating in the first direction to do at least one of (i) stop and/or (ii) operate in the second direction.

2. Aerator apparatus as claimed in claim 1, which is configured to operate in a first normal operating range, and said certain value is outwith this first normal operating range.

3. Aerator apparatus as claimed in claim 2, wherein the first normal operating range is from 85% to 95% of the current available to the motor.

4. Aerator apparatus as claimed in claim 2, wherein the apparatus is configured to switch between operating in the first normal operating range and a second normal operating range; said certain value when detected in use, being outwith the normal operating range being used by the aerator apparatus.

5. Aerator apparatus as claimed in claim 4, wherein the second normal operating range is used when a bubble diffuser operates with the aerator.

6. Aerator apparatus as claimed in claim 4, wherein the second normal operating range is 50-85% of the current available to the motor.

7. Aerator apparatus as claimed in claim 1, wherein the motor is a mechanically switched motor.

8. Aerator apparatus as claimed in claim 1, wherein the motor is a variable speed motor.

9. Aerator apparatus as claimed in claim 1, wherein the monitoring mechanism monitors the current drawn by the motor in relation to the voltage applied to the motor.

10. Aerator apparatus as claimed in claim 1, wherein the current drawn by the motor is determined by monitoring the current drawn directly.

11. Aerator apparatus as claimed in claim 1, wherein the value of current at which the control mechanism directs the motor and coupled at least one blade is stored.

12. Aerator apparatus as claimed in claim 11, wherein a plurality of said values, each corresponding to different voltages or frequencies applied to the motor, are stored.

13. Aerator apparatus as claimed in claim 1, wherein the control mechanism initially directs the motor, operating in a first direction, to (i) stop, and then directs the motor into the second direction.

14. Aerator apparatus as claimed in claim 1, wherein the control device is configured to perform cycles until the current returns to within a normal operating range, optionally in relation to one or more of the voltage and the frequency.

15. Aerator apparatus as claimed in claim 1, wherein the monitoring mechanism is adapted to monitor the current supplied to the motor with regard to potential overloading of the motor.

16. Aerator apparatus as claimed in claim 15, wherein components for monitoring the current drawn by the motor, and components adapted to monitor the potential overloading of the motor, are provided on the same device.

17. Aerator apparatus as claimed in claim 1, wherein the monitoring mechanism comprises a monitoring means to detect any sudden change or short circuit in the current supplied to the motor, and the control mechanism is adapted to suitably respond to such an event.

18. Aerator apparatus as claimed in claim 1, wherein the aerator comprises a plurality of blades which rotate around at least one central axis.

19. Aerator apparatus as claimed in claim 1, wherein the control device monitors the current drawn by the motor in real time.

20. Aerator apparatus as claimed in claim 1, wherein the motor is a three phase motor.

21. Aerator apparatus as claimed in claim 1, wherein the control mechanism further comprises a counter to record the run-time of the motor and once a pre-defined run-time has expired, at least one cycle is initiated each cycle comprising the motor being directed in the first direction, followed by a stop, followed by the second direction, followed by another stop.

22. Aerator apparatus as claimed in claim 21, wherein the run-time before a cycle is initiated is after 20 to 60 minutes of motor run-time.

23. An aerator apparatus comprising:
an aerator with at least one blade driven around a central axis and a motor coupled to the at least one blade such that operation of the motor in a first or a second direction results in operation of the blade in a corresponding first or second direction; and
a control mechanism to control the direction of the motor;
wherein after a pre-determined run-time of the motor the control mechanism is adapted to direct the motor and coupled at least one blade operating in the first direction to do at least one of (i) stop (ii) operate in the second direction.

24. Aerator apparatus as claimed in claim 23, wherein the pre-determined run time is at least 20 minutes, and is up to 1 hour.
